(19) United States
(12) Patent Application Publication
(10) Pub. No.: US 2025/0253075 A1
(43) Pub. Date: Aug. 7, 2025

(54) THIN FILM RESISTOR AND METHOD OF FABRICATING THE SAME

(71) Applicant: YAGEO CORPORATION, Kaohsiung City (TW)

(72) Inventors: Shen-Li HSIAO, Kaohsiung City (TW); Po-Hsun SHIH, Kaohsiung City (TW); Kuang-Cheng LIN, Kaohsiung City (TW)

(21) Appl. No.: 18/736,559

(22) Filed: Jun. 7, 2024

(30) Foreign Application Priority Data
Feb. 7, 2024 (TW) 113104969

(51) Int. Cl. H01C 1/06; H01C 1/142; H01C 7/00; H01C 17/242

(52) U.S. Cl. CPC H01C 1/06; H01C 1/142; H01C 7/006; H01C 17/242

(57) ABSTRACT

A thin film resistor and a method of fabricating the same are provided. The thin film resistor includes a substrate, a first end electrode, a second end electrode, a resistor layer, an electrostatic protection layer and an electrostatic electrode layer disposed on the resistor layer. The first end electrode and the second end electrode are disposed on two end portions of an upper surface of the substrate, respectively. The resistor layer and the electrostatic protection layer are disposed on the upper surface of the substrate. The electrostatic protection layer is disposed adjacent to one side of the resistor layer. The electrostatic protection layer includes two separated portions, and at least one of the two separated portions has a tip portion. Therefore, electrostatic charges can be prevented from flowing into the resistor layer, and moisture penetration into the resistor layer can be blocked.

### CROSS-REFERENCE TO RELATED APPLICATION

This application claims priority to Taiwan Application Serial Number 113104969, filed Feb. 7, 2024, which is herein incorporated by reference.

### BACKGROUND

### Field of Invention

The present invention relates to a thin film resistor and a method of fabricating the same. More particularly, the present invention relates to the thin film resistor with moisture resistance and electrostatic discharge resistance and the method of fabricating the same.

### Description of Related Art

Conventional thin film resistor includes a protection layer configured to protect a resistor layer, and a material of the protection layer is epoxy resin. However, the epoxy resin merely has basic ability to block moisture penetration and cannot completely isolate the moisture from penetrating. Therefore, the conventional thin film resistor still suffers from the risk of electrical failure, such that it cannot be applied in high-moisture environment or highly reliable electronic devices.

The conventional thin film resistor has electrostatic discharge of about 2 kV according to human body model (HBM). Generally, in order to satisfy the requirement of greater electrostatic discharge, a thickness of the resistor layer or a line width of a resistor pattern can be increased, but the aforementioned manner will result in decreasing resistance value, thereby unsatisfying requirement of high resistance value.

According to above, it is needed to provide a thin film resistor and a method of fabricating the same, thereby preventing electrostatic current from flowing into the resistor layer, and blocking the moisture penetrating into the thin film resistor.

### SUMMARY

An aspect of the present invention provides a thin film resistor, which includes an electrostatic protection layer and an electrostatic electrode layer, thereby preventing electrostatic current from flowing into a resistor layer and blocking moisture penetrating into the resistor layer.

Another aspect of the present invention provides a method of fabricating the thin film resistor, which has both of the electrostatic protection layer and the resistor layer disposed therein, and has the electrostatic electrode layer disposed on the resistor layer, thereby blocking moisture and allowing electrostatic discharge to occur in the electrostatic protection layer.

According to the aspect of the present invention, the thin film resistor is provided. The thin film resistor includes a substrate; a first end electrode disposed on one of two end portions of an upper surface of the substrate, in which the two end portions are located on respective two ends along a direction X; a second end electrode disposed on another of the two end portions of the upper surface of the substrate; a resistor layer disposed on the upper surface of the substrate and between the first end electrode and the second end electrode; at least one electrostatic protection layer disposed on the upper surface of the substrate, in which one of the at least one electrostatic protection layer is located at one side of the resistor layer, the at least one electrostatic protection layer includes a first portion and a second portion, the first portion separates from the second portion along the direction X, and at least one of the first portion and the second portion has a tip portion; and an electrostatic electrode layer disposed on the resistor layer.

According to an embodiment of the present invention, the first portion of the electrostatic protection layer has a first tip portion, the second portion has a second tip portion, and the first tip portion faces the second tip portion.

According to an embodiment of the present invention, the first portion of the electrostatic protection layer has the tip portion, the second portion has a concave portion, the concave portion faces the tip portion, and the concave portion is complementary to the tip portion.

According to an embodiment of the present invention, the electrostatic protection layer has a width along a direction Y of 7 μm to 50 μm, and the direction Y is perpendicular to the direction X.

According to an embodiment of the present invention, a distance between the first portion and the second portion of the electrostatic protection layer in the direction X is 5 μm to 30 μm.

According to an embodiment of the present invention, an angle between a boundary of an acute angle of the tip portion of the electrostatic protection layer and a horizontal line is 15° to 45°.

According to an embodiment of the present invention, the electrostatic electrode layer includes a first electrode portion and a second electrode portion, the first electrode portion is separated from the second electrode portion with spacing along the direction X, and the spacing is 10 μm to 150 μm.

According to an embodiment of the present invention, a width of the electrostatic electrode layer along the direction Y is ⅖ times to 9/10 times of a width of the substrate.

According to an embodiment of the present invention, the first electrode portion of the electrostatic electrode layer has a tip electrode, and an angle between a boundary of an acute angle of the tip electrode and a horizontal line is 30° to 90°.

According to another aspect of the present invention, the method of fabricating the thin film resistor is provided. The method includes providing a substrate; forming a first electrode pair on two end portions of the substrate, in which the two end portions are located on respective two ends along a direction X; forming a resistor layer on the substrate; forming at least one electrostatic protection layer on the substrate, in which one of the electrostatic protection layer is disposed at one side of the resistor layer, the electrostatic protection layer includes a first portion and a second portion, the first portion separates from the second portion along the direction X, and at least one of the first portion and the second portion has a tip portion; and forming an electrostatic electrode layer on the resistor layer and the electrostatic protection layer.

According to an embodiment of the present invention, the method further includes performing a laser trimming operation on the resistor layer after forming the resistor layer and the at least one electrostatic protection layer.

According to an embodiment of the present invention, the method further includes forming a passivation layer on the resistor layer after forming the resistor layer and the at least one electrostatic protection layer; and forming a protection layer on the passivation layer.

According to an embodiment of the present invention, the electrostatic electrode layer is formed by a sputtering operation, and the electrostatic electrode layer includes Cu, Cu alloy or NiCr alloy.

According to an embodiment of the present invention, the electrostatic electrode layer is formed by a printing operation, and the electrostatic electrode layer includes resin and metal.

According to the aspect of the present invention, the thin film resistor is provided. The thin film resistor includes a substrate; an electrode pair disposed on two end portions of the substrate, in which the two end portions are located on respective two ends along a first direction; a resistor layer disposed on the substrate and between the electrode pair; an electrostatic protection layer disposed on the substrate and at one side of the resistor layer along a second direction, in which the electrostatic protection layer includes a first portion and a second portion, the first portion separates from the second portion along the first direction, the first portion has a first tip portion, the first tip portion faces the second portion, and the second direction is perpendicular to the first direction; a passivation layer disposed on the resistor layer; and an electrostatic electrode layer disposed on the passivation layer, in which the electrostatic electrode layer includes a first electrode portion and a second electrode portion, the first electrode portion separates from the second electrode portion along the first direction, and the first electrode portion and the second electrode portion are complementary in shape.

According to an embodiment of the present invention, the second portion of the electrostatic protection layer has a second tip portion, and the first tip portion faces the second tip portion.

According to an embodiment of the present invention, the second portion of the electrostatic protection layer has a concave portion, the concave portion faces the first tip portion, and the concave portion is complementary to the first tip portion.

According to an embodiment of the present invention, the electrostatic protection layer has a width along the second direction of 7 μm to 50 μm, and a distance between the first portion and the second portion of the electrostatic protection layer along the first direction is 5 μm to 30 μm.

According to an embodiment of the present invention, a width of the electrostatic electrode layer along the second direction is ⅖ times to 9/10 times of a width of the substrate.

With the application of the thin film resistor and the method of fabricating the same, the electrostatic current flows into the resistor layer can be avoided and the moisture penetration can be blocked by disposition of the electrostatic protection layer and the electrostatic electrode layer.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a stereo diagram of the thin film resistor according to some embodiments of the present invention.

FIG. 2A illustrates a sectional view along line A-A in FIG. 1.

FIG. 2B illustrates a sectional view along line B-B in FIG. 1.

FIG. 2C illustrates a top view of the thin film resistor according to some embodiments of the present invention.

FIGS. 3A and 3B illustrate localized pattern schematic diagrams of the electrostatic protection layer according to some embodiments of the present invention, respectively.

FIG. 4 illustrates a top view of a portion of the thin film resistor according to some embodiments of the present invention.

FIG. 5 illustrates a localized pattern schematic diagram of the electrostatic electrode layer according to some embodiments of the present invention.

FIGS. 6A to 6C illustrate top views of intermediate stages of a process of fabricating the thin film resistor according to some embodiments of the present invention.

### DETAILED DESCRIPTION

The following disclosure provides many different embodiments, or examples, for implementing different features of the present invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, “around,” “about,” “approximately,” or “substantially” shall generally mean within 20 percent, or within 10 percent, or within 5 percent of a given value or range.

According to above, the present invention provides a thin film resistor and a method of fabricating the same, which uses an electrostatic protection layer with a specific pattern to cause high pressure difference, and low dielectric constant of epoxy resin to allow electrostatic discharge occurs in the electrostatic protection layer, thereby preventing electrostatic current from flowing into a resistor layer. In addition, the disposition of an electrostatic electrode layer is used to block moisture penetration.

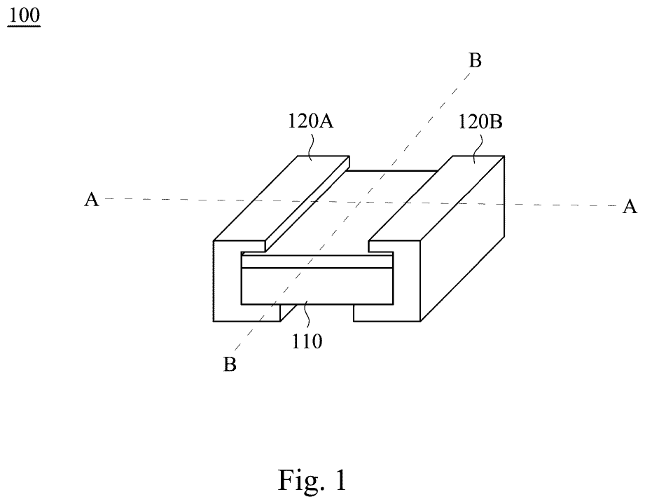

Referring to FIG. 1, FIG. 1 illustrates a stereo diagram of the thin film resistor 100 according to some embodiments of the present invention. The thin film resistor 100 includes a substrate 110, a first end electrode 120A and a second end electrode 120B, in which the first end electrode 120A and the second end electrode 120B are disposed on two end portions of the substrate 110. In some embodiments, material of the substrate 110 can be aluminum oxide, aluminum nitride, ceramic glass, and etc. In some embodiments, the first end electrode 120A and the second end electrode 120B are formed of glass, silver, electrode paste mixed with silver and palladium, or copper.

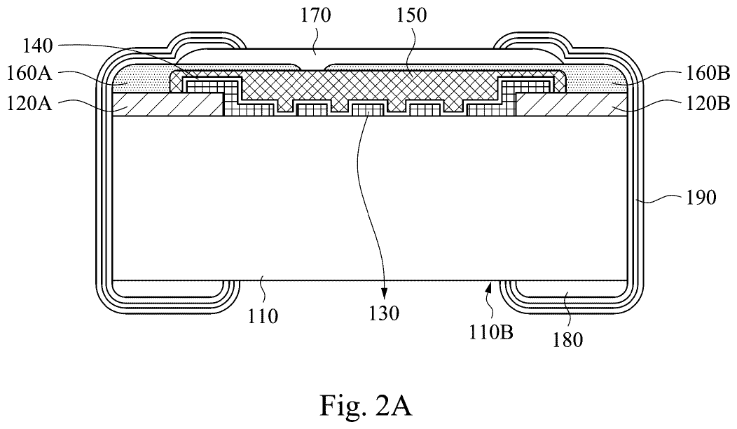

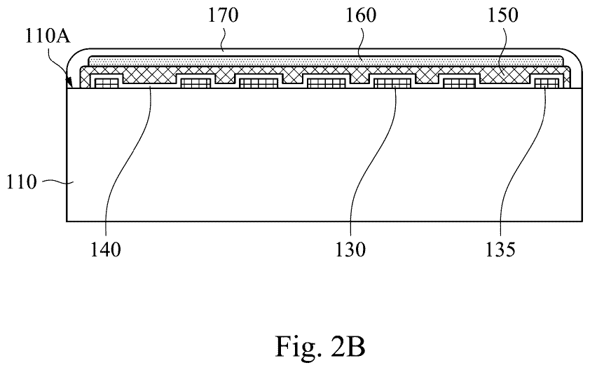

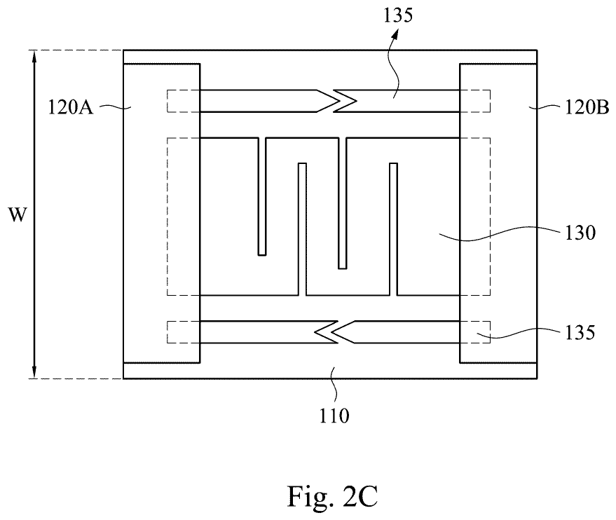

FIG. 2A illustrates a sectional view along line A-A in FIG. 1, and FIG. 2B a sectional view along line B-B in FIG. 1. Referring to FIGS. 2A and 2B, the thin film resistor 100 includes a resistor layer 130, in which the resistor layer 130 is disposed on an upper surface 110A of the substrate 110. The resistor layer 130 is located between the first end electrode 120A and the second end electrode 120B. In some embodiments, as shown in FIG. 2A, the resistor layer 130 is partially disposed on portions of the first end electrode 120A and the second end electrode 120B. In some embodiments, material of the resistor layer 130 includes but are not limited to nickel-chromium (NiCr), copper-nickel (CuNi), nickel-chromium-silicon (NiCrSi), nickel-chromium-aluminum (NiCrAl), nickel-chromium-aluminum-silicon (NiCrAlSi), nickel-chromium-aluminum-Yttrium (NiCrAlY), nickel-chromium-tantalum-molybdenum (NiCrTaMo), tantalum nitride (TaN), copper-manganese-tin (CuMnSn), copper-manganese-nickel (CuMnNi), gold or other suitable resistor material.

The thin film resistor 100 includes an electrostatic protection layer 135, in which the electrostatic protection layer 135 is disposed on the upper surface 110A of the substrate 110, as shown in FIG. 2B. The electrostatic protection layer 135 is disposed in parallel with one side of the resistor layer 130. Referring to FIG. 2C, FIG. 2C illustrates a top view of the thin film resistor 100 according to some embodiments of the present invention. When the thin film resistor 100 includes two electrostatic protection layers 135, which can respectively disposed on upper side and lower side of the resistor layer 130, as shown in FIG. 2C. If only one electrostatic protection layer 135 is disposed, it can be disposed on upper side of the resistor layer 130. However, numbers of the electrostatic protection layer 135 is not limited; it can be adjusted according to requirement. In some embodiments, the electrostatic protection layer 135 is partially disposed on portions of the first end electrode 120A and the second end electrode 120B.

In some embodiments, material of the electrostatic protection layer 135 can include but are not limited to nickel-chromium (NiCr), copper-nickel (CuNi), nickel-chromium-silicon (NiCrSi), nickel-chromium-aluminum (NiCrAl), nickel-chromium-aluminum-silicon (NiCrAlSi), nickel-chromium-aluminum-Yttrium (NiCrAlY), nickel-chromium-tantalum-molybdenum (NiCrTaMo), tantalum nitride (TaN), copper-manganese-tin (CuMnSn), copper-manganese-nickel (CuMnNi), gold or other suitable resistor material.

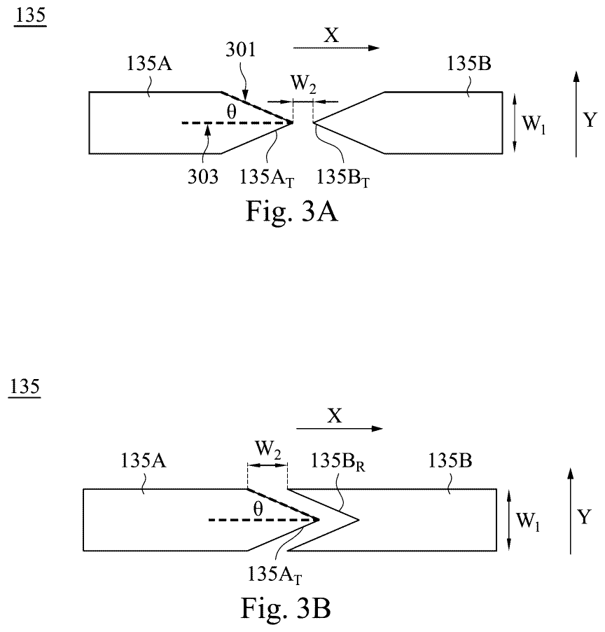

FIGS. 3A and 3B illustrate localized pattern schematic diagrams of the electrostatic protection layer 135 according to some embodiments of the present invention, respectively. The electrostatic protection layer 135 includes a first portion 135A and a second portion 135B, and the first portion 135A separates from the second portion 135B in a direction X. In some embodiments, at least one of the first portion 135A and the second portion 135B is necessarily to have a tip portion, so as to have electrostatic discharge effect.

In some embodiments, as shown in FIG. 3A, the first portion 135A of the electrostatic protection layer 135 has a first tip portion 135A_{T}, and the second portion 135B has a second tip portion 135B_{T}. The first tip portion 135A_{T} faces the second tip portion 135B_{T}, and the first tip portion 135A_{T} separates from the second tip portion 135B_{T} with a distance W₂. In some embodiments, the distance W₂ is in a range of about 5 μm to about 30 μm. When the distance W₂ is within the above range, the electrostatic protection layer 135 can have corona discharge effect, and is easier to be manufactured in-process. In some embodiments, an angle θ between a boundary 301 of an acute angle of the first tip portion 135A_{T} and a horizontal line 303 is about 15° to about 45°, and preferably 30°. When the angle θ is within the above range, the electrostatic protection layer 135 can have electrostatic discharge effect, and is easier to be manufactured in-process. The second tip portion 135B_{T} is symmetrical to the first tip portion 135A_{T}, thus having a similar angle as the first tip portion 135A_{T}. In some embodiments, the electrostatic protection layer 135 has a width W₁ along a direction Y of about 7 μm to about 50 μm. When the width W₁ is within the above range, the space of the resistor layer 130 is not occupied, and is easier to be manufactured in-process.

In some embodiments, as shown in FIG. 3B, the first portion 135A of the electrostatic protection layer 135 has a first tip portion 135A_{T}, and the second portion 135B has a concave portion 135B_{R}. The first tip portion 135A_{T} faces the concave portion 135B_{R}, and the first tip portion 135A_{T} and the concave portion 135B_{R} are complementary. The first tip portion 135A_{T} separates from the concave portion 135B_{R} with a distance W₂. In some embodiments, the distance W₂ is in a range of about 5 μm to about 30 μm. When the distance W₂ is within the above range, the electrostatic protection layer 135 can have corona discharge effect, and is easier to be manufactured in-process. In some embodiments, the angle θ between a boundary of an acute angle of the first tip portion 135A_{T} and a horizontal line 303 is about 15° to about 45°, and preferably 30°. When the angle θ is within the above range, the electrostatic protection layer 135 can have electrostatic discharge effect, and is easier to be manufactured in-process. In some embodiments, the electrostatic protection layer 135 has a width W₁ along the direction Y of about 7 μm to about 50 μm. When the width W₁ is within the above range, the space of the resistor layer 130 is not occupied, and is easier to be manufactured in-process.

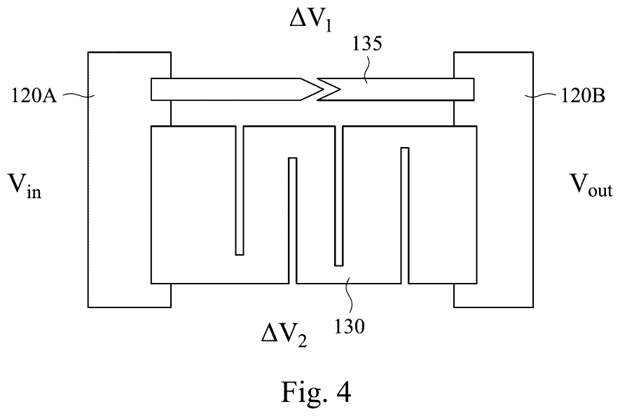

FIG. 4 illustrates a top view of a portion of the thin film resistor 100 according to some embodiments of the present invention. As shown in FIG. 4, if the first end electrode 120A has a voltage Vᵢₙ, and the second end electrode 120B has a voltage Vₒᵤₜ, the electrostatic protection layer 135 has a voltage difference ΔV1 of (Vᵢₙ−Vₒᵤₜ). A voltage difference ΔV2 between adjacent resistor circuits within the resistor layer 130 is the voltage difference (Vᵢₙ−Vₒᵤₜ) input to the resistor divided by numbers of laser trimming N, which means

$$ΔV2 = \frac{( V in - V out )}{N} .$$

Therefore, the voltage difference ΔV1 of the electrostatic protection layer 135 should be far greater than the voltage difference ΔV2 between adjacent resistor circuits within the resistor layer 130. As such, when the electrostatic discharge occurs, it can be released from the electrostatic protection layer 135, thereby effectively preventing the electrostatic current from flowing into the resistor layer 130.

Referring to FIGS. 2A and 2B again, in some embodiments, the thin film resistor 100 further includes a passivation layer 140 and a protection layer 150, in which the passivation layer 140 fully covers the resistor layer 130. That is, the passivation layer 140 is conformally disposed on the resistor layer 130. In some embodiments, the passivation layer 140 is formed by silicon oxide, tantalum oxide, silicon nitride or combinations thereof. The protection layer 150 is disposed on the passivation layer 140, and fully covers the passivation layer 140. In addition, as shown in FIG. 2A, the protection layer 150 further partially covers the first end electrode 120A and the second end electrode 120B. In some embodiments, the protection layer 150 is formed by epoxy resin or resin.

The thin film resistor 100 includes an electrostatic electrode layer 160 disposed on the protection layer 150. In some embodiments, material of the electrostatic electrode layer 160 includes copper, copper alloy, nickel-chromium alloy or combinations thereof. The electrostatic electrode layer 160 uses dielectric properties of metal of the aforementioned materials, such that structures are denser to act as a moisture barrier layer, which can effectively block the moisture penetration. Furthermore, since the electrostatic electrode layer 160 includes metal materials, it can increase thermal conductivity of the protection layer 150, and further help heat resulted from the resistor conduct to the first end electrode 120A and the second end electrode 120B rapidly.

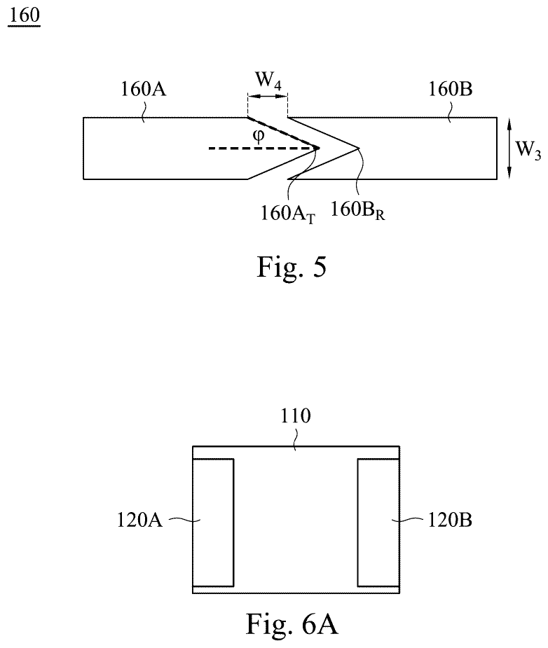

In some embodiments, as shown in FIG. 2A, the electrostatic electrode layer 160 includes a first electrode portion 160A and a second electrode portion 160B separated from the first electrode portion 160A. The first electrode portion 160A partially covers the first end electrode 120A, and the second electrode portion 160B partially covers the second end electrode 120B. Referring to FIG. 5, FIG. 5 illustrates a localized pattern schematic diagram of the electrostatic electrode layer 160 according to some embodiments of the present invention. In some embodiments, similar to the electrostatic protection layer 135, the first electrode portion 160A has a tip electrode 160A_{T}, while the second electrode portion 160B has a concave electrode 160B_{R}, the tip electrode 160A_{T} faces the concave electrode 160B_{R}, and the tip electrode 160A_{T} and the concave electrode 160B_{R} are complementary. The electrostatic electrode layer 160 with specific pattern can achieve secondary electrostatic protection between the electrostatic electrode layer 160 and the protection layer 150.

As shown in FIG. 5, in some embodiments, a width W₃ of the electrostatic electrode layer 160 along the direction Y is about ⅖ times to about 9/10 times of a width W of the substrate 110 (referring to FIG. 2C), that is

$$\frac{2}{5} W \leq {W}_{3} \leq \frac{9}{10} W .$$

When the width W₃ is within the above range, the two effects of avoiding short circuit and blocking moisture can be achieved. In some embodiments, the tip electrode 160A_{T} of the first electrode portion 160A of the electrostatic electrode layer 160 separates from the concave electrode 160B_{R} of the second electrode portion 160B along the direction X with a spacing W₄, which is in a range of about 10 μm to about 150 μm. When the spacing W₄ is within the above range, the electrostatic electrode layer 160 can have corona discharge effect, and is easier to be manufactured in-process. In some embodiments, an angle φ between a boundary 501 of an acute angle of the tip electrode 160A_{T} and a horizontal line 503 is about 30° to about 90°. When the angle φ is within the above range, the electrostatic electrode layer 160 can have electrostatic discharge effect, and is easier to be manufactured in-process.

In some embodiments, the thin film resistor 100 further includes an insulating protection layer 170. The insulating protection layer 170 is disposed on the electrostatic electrode layer 160 and the protection layer 150. Similar to the protection layer 150, the material of the insulating protection layer 170 can be epoxy resin or resin.

The thin film resistor 100 further includes back electrodes 180 and outer electrodes 190. The back electrodes 180 are disposed on a lower surface 110B of the substrate 110, and the outer electrodes 190 are disposed on lateral surfaces of the substrate 110. In some embodiments, the outer electrodes 190 are connected to the back electrodes. In some embodiments, the back electrodes 180 are formed from the combination of epoxy resin and silver.

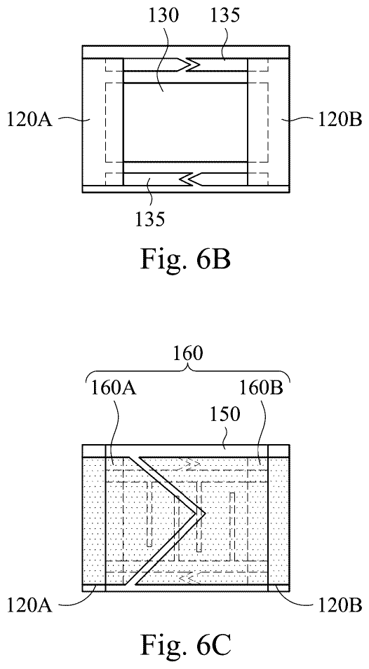

FIGS. 6A to 6C illustrate top views of intermediate stages of a process of fabricating the thin film resistor 100 according to some embodiments of the present invention. The process of fabricating the thin film resistor 100 is discussed in the following by FIGS. 6A to 6C. First, referring to FIG. 6A, the substrate 110 is provided, and a first electrode pair (i.e. the first end electrode 120A and the second end electrode 120B) is formed on two ends of the substrate. In some embodiments, when the material of the first electrode pair is glass, silver or electrode paste of silver and palladium, it is formed by using printing or sintering. In other embodiments, when the material of the first electrode pair is copper, it can be formed by sputtering.

Subsequently, referring to FIG. 6B, the resistor layer 130 and the electrostatic protection layer 135 are formed on the substrate 110. In some embodiments, the resistor layer 130 and the electrostatic protection layer 135 are formed by sputtering. In some embodiments, before sputtering, a removable blocking layer (or a mask) can be formed by printing or photolithography, so as to expose areas for sputtering the resistor layer 130 and the electrostatic protection layer 135 and portions of the first end electrode 120A and the second end electrode 120B.

Hereafter, after forming the resistor layer 130 and the electrostatic protection layer 135, the blocking layer is removed by a stripper solution. In some embodiments, a laser trimming step can be performed on the resistor layer 130, which can adjust resistance value of the resistor by laser or a physical processing.

In some embodiments, another blocking layer can be formed on the first end electrode 120A and the second end electrode 120B by printing or photolithography. Then, the passivation layer 140 is formed on the resistor layer 130. In some embodiments, the passivation layer 140 is formed by sputtering or chemical vapor deposition (CVD). Similarly, the blocking layer is removed by the stripper solution.

Subsequently, referring to FIG. 6C, the protection layer 150 is formed on the passivation layer 140, and the protection layer 150 fully covers the passivation layer 140, and partially covers the first end electrode 120A and the second end electrode 120B. In some embodiments, the protection layer 150 can be formed by printing or photolithography. Then, the electrostatic electrode layer 160 is formed on the protection layer 150, the first end electrode 120A and the second end electrode 120B. The electrostatic electrode layer 160 includes the first electrode portion 160A and the second electrode portion 160B, in which the first electrode portion 160A is separated from the second electrode portion 160B, and a portion of the protection layer 150 is exposed. In some embodiments, the electrostatic electrode layer 160 is formed by printing, and the material can be a resin electrode composed of epoxy resin and silver. In other embodiments, the electrostatic electrode layer 160 can be formed by sputtering, and the sputtering material can be copper, copper alloy or nickel-chromium alloy.

In some embodiments, the insulating protection layer 170 (see FIG. 2A) can be formed by printing or photolithography afterwards. Then, the back electrode 180 (see FIG. 2A) can be formed on the lower surface 110B of the substrate 110 by printing. Subsequently, a connecting layer can be formed on the lateral surfaces of the substrate 110 by sputtering nickel-chromium alloy, and the outer electrode 190 (see FIG. 2A) of a nickel layer and a tin layer is formed in order by electroplating.

According to above, the present invention provides the thin film resistor and the method of fabricating the same, which uses the electrostatic protection layer with the specific pattern to cause high pressure difference, and low dielectric constant of epoxy resin to allow electrostatic discharge occurs in the electrostatic protection layer, thereby preventing electrostatic current from flowing into the resistor layer. In addition, the disposition of the electrostatic electrode layer is used to block moisture penetration.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A thin film resistor, comprising:
a substrate;
a first end electrode, disposed on one of two end portions of an upper surface of the substrate, wherein the two end portions are located on respective two ends along a direction X;
a second end electrode, disposed on another of the two end portions of the upper surface of the substrate;
a resistor layer, disposed on the upper surface of the substrate and between the first end electrode and the second end electrode;
at least one electrostatic protection layer, disposed on the upper surface of the substrate, wherein one of the at least one electrostatic protection layer is located at one side of the resistor layer, the at least one electrostatic protection layer comprises a first portion and a second portion, the first portion separates from the second portion along the direction X, and at least one of the first portion and the second portion has a tip portion; and
an electrostatic electrode layer, disposed on the resistor layer.

2. The thin film resistor of claim 1, wherein the first portion of the at least one electrostatic protection layer has a first tip portion, the second portion has a second tip portion, and the first tip portion faces the second tip portion.

3. The thin film resistor of claim 1, wherein the first portion of the at least one electrostatic protection layer has the tip portion, the second portion has a concave portion, the concave portion faces the tip portion, and the concave portion is complementary to the tip portion.

4. The thin film resistor of claim 1, wherein the at least one electrostatic protection layer has a width along a direction Y of 7 μm to 50 μm, and the direction Y is perpendicular to the direction X.

5. The thin film resistor of claim 1, wherein a distance between the first portion and the second portion of the at least one electrostatic protection layer in the direction X is 5 μm to 30 μm.

6. The thin film resistor of claim 1, wherein an angle between a boundary of an acute angle of the tip portion of the at least one electrostatic protection layer and a horizontal line is 15° to 45°.

7. The thin film resistor of claim 1, wherein the electrostatic electrode layer comprises a first electrode portion and a second electrode portion, the first electrode portion is separated from the second electrode portion with spacing along the direction X, and the spacing is 10 μm to 150 μm.

8. The thin film resistor of claim 7, wherein a width of the electrostatic electrode layer along a direction Y is ⅖ times to 9/10 times of a width of the substrate.

9. The thin film resistor of claim 7, wherein the first electrode portion of the electrostatic electrode layer has a tip electrode, and an angle between a boundary of an acute angle of the tip electrode and a horizontal line is 30° to 90°.

10. A method of fabricating a thin film resistor, comprising:
providing a substrate;
forming a first electrode pair on two end portions of the substrate, wherein the two end portions are located on respective two ends along a direction X;
forming a resistor layer on the substrate;
forming at least one electrostatic protection layer on the substrate, wherein one of the at least one electrostatic protection layer is disposed at one side of the resistor layer, the at least one electrostatic protection layer comprises a first portion and a second portion, the first portion separates from the second portion along the direction X, and at least one of the first portion and the second portion has a tip portion; and
forming an electrostatic electrode layer on the resistor layer and the at least one electrostatic protection layer.

11. The method of fabricating the thin film resistor of claim 10, further comprising:
performing a laser trimming operation on the resistor layer after forming the resistor layer and the at least one electrostatic protection layer.

12. The method of fabricating the thin film resistor of claim 10, further comprising:
forming a passivation layer on the resistor layer after forming the resistor layer and the at least one electrostatic protection layer; and
forming a protection layer on the passivation layer.

13. The method of fabricating the thin film resistor of claim 12, wherein forming the electrostatic electrode layer comprises:
forming the electrostatic electrode layer on the protection layer.

14. The method of fabricating the thin film resistor of claim 10, wherein the electrostatic electrode layer is formed by a sputtering operation, and the electrostatic electrode layer comprises Cu, Cu alloy or NiCr alloy.

15. The method of fabricating the thin film resistor of claim 10, wherein the electrostatic electrode layer is formed by a printing operation, and the electrostatic electrode layer comprises resin and metal.

16. A thin film resistor, comprising:
a substrate;
an electrode pair, disposed on two end portions of the substrate, wherein the two end portions are located on respective two ends along a first direction;
a resistor layer, disposed on the substrate and between the electrode pair;
an electrostatic protection layer, disposed on the substrate and at one side of the resistor layer along a second direction, wherein the electrostatic protection layer comprises a first portion and a second portion, the first portion separates from the second portion along the first direction, the first portion has a first tip portion, the first tip portion faces the second portion, and the second direction is perpendicular to the first direction;
a passivation layer, disposed on the resistor layer; and
an electrostatic electrode layer, disposed on the passivation layer, wherein the electrostatic electrode layer comprises a first electrode portion and a second electrode portion, the first electrode portion separates from the second electrode portion along the first direction, and the first electrode portion and the second electrode portion are complementary in shape.

17. The thin film resistor of claim 16, wherein the second portion of the electrostatic protection layer has a second tip portion, and the first tip portion faces the second tip portion.

18. The thin film resistor of claim 16, wherein the second portion of the electrostatic protection layer has a concave portion, the concave portion faces the first tip portion, and the concave portion is complementary to the first tip portion.

19. The thin film resistor of claim 16, wherein the electrostatic protection layer has a width along the second direction of 7 μm to 50 μm, and a distance between the first portion and the second portion of the electrostatic protection layer along the first direction is 5 μm to 30 μm.

20. The thin film resistor of claim 16, wherein a width of the electrostatic electrode layer along the second direction is ⅖ times to 9/10 times of a width of the substrate.
